(19) United States
(12) Patent Application Publication
(10) Pub. No.: US 2022/0295323 A1
(43) Pub. Date: Sep. 15, 2022

(54) MEASUREMENT CONFIGURATION AND REPORTING METHOD, APPARATUS AND USER DEVICE

(71) Applicant: BEIJING UNISOC COMMUNICATIONS TECHNOLOGY CO., LTD., Beijing (CN)

(72) Inventor: Hualei WANG, Shanghai (CN)

(73) Assignee: BEIJING UNISOC COMMUNICATIONS TECHNOLOGY CO., LTD., Beijing (CN)

(21) Appl. No.: 17/635,622

(22) PCT Filed: Aug. 13, 2020
(86) PCT No.: PCT/CN2020/108765

§ 371 Date: Feb. 15, 2022

(30) Foreign Application Priority Data
Aug. 16, 2019 (CN) 201910758150.1

(51) Int. Cl. H04W 24/10; H04B 17/336; H04B 17/318

(52) U.S. Cl. CPC H04W 24/10; H04B 17/336; H04B 17/318

(57) ABSTRACT

The present invention provides a measurement configuration and reporting method, an apparatus and a user device. The method comprises: receiving a network configuration information, the network configuration information at least comprises a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam; measuring a non-serving cell based on the network configuration information to obtain a measurement result; and reporting the measurement result of the non-serving cell to a network, in response to a preset condition being satisfied.

### CROSS-REFERENCE TO RELATED APPLICATIONS

This application is the national phase of International Application No. PCT/CN2020/108765, filed on Aug. 13, 2020, which claims priority to Chinese Patent Application No. 201910758150.1, filed on Aug. 16, 2019, and entitled “MEASUREMENT CONFIGURATION AND REPORTING METHOD, APPARATUS AND USER DEVICE”, the entire disclosures of which are incorporated herein by reference.

### TECHNICAL FIELD

The present disclosure generally relates to wireless communication technology field, and more particularly, to a method and apparatus for measuring configuration and reporting and a user device.

### BACKGROUND

Currently, the New Radio (NR) supports a measurement and report of a Layer 3 (L3) beam for a non-serving cell. Specifically, a measurement configuration is configured through a MeasConfig, and the measurement configuration includes a measurement target and a report configuration information.

The NR also supports a measurement and report of a Layer 1/Layer 2 (L1/L2) beam for a serving cell. Specifically, a measurement configuration is configured through a Channel State Information (CSI)-MeasConfig, and the measurement configuration includes a measurement target and a report configuration information.

Currently, there is a need for supporting a measurement and report of a L1/L2 beam for a non-serving cell.

### SUMMARY

Embodiments of the present disclosure provide a method for measuring configuration and reporting, which can realize the measurement and report of a L1/L2 beam for a non-serving cell.

In an embodiment of the present disclosure, a method for measuring configuration and reporting is provided, the method includes: receiving a network configuration information, wherein the network configuration information at least includes a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam; measuring a non-serving cell based on the network configuration information to obtain a measurement result; and reporting the measurement result for the non-serving cell to a network, in response to a preset condition being satisfied.

In an embodiment of the present disclosure, an apparatus for measuring configuration and reporting is provided, the apparatus includes: a receiving circuitry, adapted to receive a network configuration information, wherein the network configuration information at least includes a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam; a measuring circuitry, adapted to measure a non-serving cell based on the network configuration information to obtain a measurement result; and a reporting circuitry, adapted to report the measurement result for the non-serving cell to a network, in response to a preset condition being satisfied.

In an embodiment of the present disclosure, a User Equipment (UE) is provided, the UE includes an apparatus for measuring configuration and reporting according to any one of above embodiments.

### BRIEF DESCRIPTION OF THE DRAWINGS

FIG. 1 schematically illustrates a flowchart of a method for measuring configuration and reporting according to an embodiment of the present disclosure; and

FIG. 2 schematically illustrates a structural diagram of an apparatus for measuring configuration and reporting according to an embodiment of the present disclosure.

### DETAILED DESCRIPTION

In order to clarify the object, characteristic and advantages of embodiments of the present disclosure, the embodiments of present disclosure will be described clearly in detail in conjunction with accompanying drawings. Obviously, described embodiments are only some, but not all, embodiments of the present disclosure. Based on the embodiments of the present disclosure, all other embodiments obtained by those of ordinary skill in the art without creative efforts shall fall within the protection scope of the present disclosure.

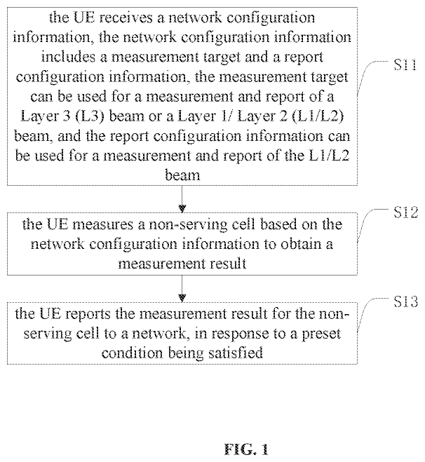

Embodiments of the present disclosure provide a method for measuring configuration and reporting, the method may be applied to at a UE side, as shown in FIG. 1, the method may include S11, S12 and S13.

In S11, the UE receives a network configuration information, the network configuration information includes a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam.

Wherein, the measurement target may at least include a reference signal for measurement or an SSB information, and a cell index information.

Wherein, the L1 represents a physical layer, the L2 represents a data link layer, and the L3 represents a network layer.

In S12, the UE measures a non-serving cell based on the network configuration information to obtain a measurement result.

In S13, the UE reports the measurement result for the non-serving cell to a network, in response to a preset condition being satisfied.

In embodiments of the present disclosure, the network configuration information received by the UE includes the measurement target and the report configuration information, the measurement target can be used for the measurement and report of the L3 beam and the L1/L2 beam, and the report configuration information can be used for a measurement and report of the L1/L2 beam. The UE may measure a non-serving cell based on the network configuration information to obtain a measurement result; and report the measurement result of the non-serving cell to a network in response to a preset condition being satisfied. In doing so, the measurement and report of the L1/L2 beam for the non-serving cell can be achieved consequently.

Following describes the method for measuring configuration and reporting in detail according to embodiments of the present disclosure.

A report configuration information in a network configuration information received by a UE may include one selected from a group consisting of following information.

(1) a report configuration type, wherein the report configuration type includes an event triggering.

The report configuration type may be used for triggering a terminal to measure and report. The report configuration type includes an event triggering in response to a certain condition being satisfied, the L1/L2 can be reported, which reduces overhead and complexity.

(2) a report Quantity, wherein the report Quantity at least includes three options: a Channel State Information-Reference Signal (CSI-RS) Resource Indicator-Reference Signal Receiving Power (CRI-RSRP), a Synchronization Signal Block-Index-Reference Signal Receiving Power (SSB-Index-RSRP), and a none.

Wherein, there are three ways to configure the CSI-RS reference signal in NR. The CSI-RS reference signal can be configured with a periodic transmission type, or can also be configured with an aperiodic or a semi-persistent transmission type semi-statically through a high-layer signaling. Because the CSI-RS can be used for configurations for a plurality of resources, the UE may determine a measurement resource related to the CSI reporting through the CRI. If the UE needs to measure and report a physical layer channel RSRP in a connected state, the CSI can be reported and configured as a CSI based on the CRI-RSRP or the SSB-Index-RSRP. The configuration can give the UE more flexibility. In the connected state, the UE may evaluate a channel coverage situation by measuring the CSI-RS, and the UE may also evaluate a channel coverage situation through an SSB beam. This information is fed back to a base station, and the base station can comprehensively optimize and adjust according to a specific algorithm.

(3) a group-based beam report, if the group-based beam report is enabled, it supports a group-based report, and if the group-based beam report is not enabled, it does not support a group-based report.

Specifically, whether the group-based report is supported may be indicated by a flag bit, if the flag bit is 1, the group-based beam report is enabled, and if the flag bit is 2, the group-based beam report is not enabled.

(4) a measurement cell information, wherein the measurement cell information may include a supported maximum number of reporting cells.

By setting the maximum number of reporting cells supported by the UE, and limiting a number of reported cells, the complexity of the terminal can be reduced and the network signaling overhead can be reduced.

In some embodiment, the network may configure the report configuration information of the L1/L2 beam in the measurement configuration information MeasConfig.

Wherein, a measurement object used for the measurement and report of the L1/L2 beam for the non-serving cell may also be a measurement object configured in the MeasConfig. That is, the measurement object may be used for the measurement and report of the L3 beam for the non-serving cell, and the measurement object may also be used for a measurement and report of L1/L2 beam for the non-serving cell, which can reduce the network overhead effectively.

Further, the L3 measurement report configuration information for the non-serving cell is configured in the MeasConfig, in some embodiment, the report configuration type configured in the measurement report configuration information is consistent with the report configuration type configured in the L1/L2 measurement report configuration information of the configured serving cell. In this way, the measurement and report of the L1/L2 for the non-serving cell can be realized without increasing the complexity of the UE.

The preset condition need to be satisfied by the UE to report the measurement result for the non-serving cell to the network include: the measurement result for the non-serving cell is better than the serving cell within a predetermined time, but it is not limited to that. Specifically, the measurement result for the non-serving cell reported to the network by the UE may include one selected from a group consisting of: a cell index, a reference signal index or an SSB index, and an RSRP or an SINR value.

That is, the measurement result for the non-serving cell reported to the network by the UE may include at least one of the cell index, the reference signal index and the RSRP; or may include at least one of the cell index, the SSB index and the RSRP; or may include at least one of the cell index, the reference signal index and the SINR, or may include at least one of the cell index, the SSB index and the RSRP.

Wherein, the RSRP refers to an average value of signal power received on all Resource Elements (RE) carrying reference signals in a certain symbol, and the SINR refers to a ratio of strength of a received wanted signal to strength of a received interfering signal (noise and interference).

In some embodiment, if a measurement result RSRP or an SINR of a certain reference signal or an SSB is better than an RSRP or an SINR of the serving cell within a predetermined time, the UE may send the measurement result to the network.

Specifically, a timing for the UE to send the above measurement result to the network may include: a measurement result RSRP of a certain reference signal in the non-serving cell is better than the RSRP of the serving cell within a predetermined time; or, a measurement result SINR of a certain reference signal in the non-serving cell is better than the SINR of the serving cell within a predetermined time; or, a measurement result RSRP of a certain SSB in the non-serving cell is better than the RSRP of the serving cell within a predetermined time; or, a measurement result SINR of a certain SSB in the non-serving cell is better than the SINR of the serving cell within a predetermined time, which makes the timing for the measurement and report more flexible.

In some embodiment, when a preset condition is satisfied, the UE may report the measurement result for the non-serving cell to a source cell.

Further, the measurement result for the non-serving cell reported to the network by the UE may be carried by a Medium Access Control (MAC) Control Element (CE).

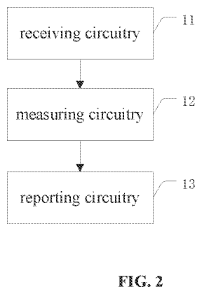

Embodiments of the present disclosure provide an apparatus for measuring configuration and reporting, as shown in FIG. 2, the apparatus may include following circuitries.

A receiving circuitry 11 is adapted to receive a network configuration information, wherein the network configuration information includes a measurement target and a report configuration information, the measurement target can be used for a measurement and report of a L3 beam or a L1/L2 beam, and the report configuration information can be used for a measurement and report of the L1/L2 beam.

A measuring circuitry 12 is adapted to measure a non-serving cell based on the network configuration information to obtain a measurement result.

A reporting circuitry 13 is adapted to report the measurement results for the non-serving cell to a network, in response to a preset condition being satisfied.

In apparatuses for measuring configuration and reporting provided in embodiments of the present disclosure, a network configuration information received by a UE includes a measurement target and a report configuration information, the measurement target can be used for a measurement and report of a L3 beam or a L1/L2 beam, and the report configuration information can be used for a measurement and report of the L1/L2 beam. The UE may measure a non-serving cell based on the network configuration information to obtain a measurement result; and report the measurement result for the non-serving cell to a network in response to a preset condition being satisfied. In doing so, the measurement and report of the L1/L2 beam for the non-serving cell can be achieved consequently.

In some embodiment, the report configuration information may at least include one selected from a group consisting of: a report configuration type, a report Quantity, a group-based beam reporting, and a measurement cell information.

In some embodiment, the report configuration type may at least include an event triggering.

In some embodiment, the report Quantity may at least include three options: CRI-RSRP, SSB-Index-RSRP and none.

In some embodiment, the measurement cell information includes a supported maximum number of reporting cells.

In some embodiment, the preset condition includes: the measurement results for the non-serving cell being better than the serving cell within a predetermined time.

In some embodiment, the reporting circuitry 13 is also adapted to report one to the network selected from a group consisting of: a cell index, a reference signal index or an SSB index and an RSRP or an SINR value.

In some embodiment, the reporting circuitry 13 is adapted to report the measurement result for the non-serving cell to the source cell when the preset condition is satisfied.

Further, the measurement result for the non-serving cell reported to the network by the reporting circuitry 13 may be carried by the MACCE.

An embodiment of the present disclosure provides a UE which may include above mentioned apparatus for measuring configuration and reporting.

Those of ordinary skill in the art can understand that all or part of the processes in the above embodiments of method can be implemented by instructing relevant hardware through a computer program, and the program can be stored in a computer-readable storage medium. During execution, the processes of the embodiments of the above-mentioned methods may be included. The storage medium may be a magnetic disk, an optical disk, a Read-Only Memory (ROM), or a Random Access Memory (RAM) or the like.

Although the present disclosure is disclosed as above, the present disclosure is not limited to this. Those skilled in the art can make various changes and modifications without departing from the spirit and scope of the present disclosure. Therefore, the protection scope of the present disclosure should be subject to the scope defined by the claims.

1. A method for measuring configuration and reporting, comprising:
receiving a network configuration information, wherein the network configuration information at least comprises a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam;
measuring a non-serving cell based on the network configuration information to obtain a measurement result; and
reporting the measurement result for the non-serving cell to a network, in response to a preset condition being satisfied.

2. The method according to claim 1, wherein the report configuration information at least comprises one selected from a group consisting of: a report configuration type, a report Quantity, a group-based beam report, and a measurement cell information.

3. The method according to claim 2, wherein the report configuration type at least comprises an event triggering.

4. The method according to claim 2, wherein the report Quantity at least comprises three options: a Channel State Information-Reference Signal (CSI-RS) Resource Indicator-Reference Signal Receiving Power (CRI-RSRP), a Synchronization Signal Block-Index-Reference Signal Receiving Power (SSB-Index-RSRP) and a none.

5. The method according to claim 2, wherein the measurement cell information comprises a supported maximum number of reporting cells.

6. The method according to claim 1, wherein the preset condition comprises: the measurement results for the non-serving cell being better than the serving cell within a predetermined time.

7. The method according to claim 1, wherein said reporting the measurement result for the non-serving cell to a network comprises: reporting one to the network selected from a group consisting of: a cell index, a reference signal index or an SSB index, and an RSRP or a Signal to Interference plus Noise Ratio (SINR) value.

8. An apparatus for measuring configuration and reporting, comprising:
a receiving circuitry, adapted to receive a network configuration information, wherein the network configuration information at least comprises a measurement target and a report configuration information, the measurement target can be used for a measurement and report of a Layer 3 (L3) beam or a Layer 1/Layer 2 (L1/L2) beam, and the report configuration information can be used for a measurement and report of the L1/L2 beam;
a measuring circuitry, adapted to measure a non-serving cell based on the network configuration information to obtain a measurement result; and
a reporting circuitry, adapted to report the measurement result for the non-serving cell to a network, in response to a preset condition being satisfied.

9. The apparatus according to claim 8, wherein the report configuration information at least comprises one selected from a group consisting of: a report configuration type, a report Quantity, a group-based beam report, and a measurement cell information.

10. The apparatus according to claim 9, wherein the report configuration type at least comprises an event triggering.

11. The apparatus according to claim 9, wherein the report Quantity at least comprises three options: a Channel State Information-Reference Signal (CSI-RS) Resource Indicator-Reference Signal Receiving Power (CRI-RSRP), a Synchronization Signal Block-Index-Reference Signal Receiving Power (SSB-Index-RSRP) and a none.

12. The apparatus according to claim 9, wherein the measurement cell information comprises a supported maximum number of reporting cells.

13. The apparatus according to claim 8, wherein the preset condition comprises: the measurement results for the non-serving cell being better than the serving cell within a predetermined time.

14. The apparatus according to claim 8, wherein said reporting the measurement result for the non-serving cell to a network comprises: reporting one to the network selected from a group consisting of: a cell index, a reference signal index or an SSB index, and an RSRP or a Signal to Interference plus Noise Ratio (SINR) value.

15. A User Equipment (UE), wherein the UE comprises an apparatus for measuring configuration and reporting according to claim 1.
